(19) United States
(12) Patent Application Publication
(10) Pub. No.: US 2026/0236723 A1
(43) Pub. Date: Aug. 13, 2026

(54) Dynamic Reader Device Control

(71) Applicant: Trilliott, Inc., Raleigh, NC (US)

(72) Inventor: James Booth Kalmbach, JR., Raleigh, NC (US)

(21) Appl. No.: 19/633,726

(22) Filed: Mar. 30, 2026

Related U.S. Application Data
(63) Continuation-in-part of application No. 18/477,913, filed on Sep. 29, 2023.

(51) Int. Cl. G06K 7/10

(52) U.S. Cl. CPC G06K 7/10366

(57) ABSTRACT

The system herein described presents data capture from multiple tags associated with items, locations, and devices within a facility utilizing a customized WebSocket-based message protocol that enables efficient bidirectional peer-to-peer communication regardless of endpoints being collocated on a LAN or connected over the Internet. The system and methods initialize and facilitate communication for the capture of tag data encapsulated within a JSON message body using REST-like methods acting on REST-like resources. The blending of WebSocket, REST, and JSON forms the unique TT-REST request-response protocol.

### CROSS-REFERENCE TO RELATED APPLICATION

This application claims priority as a continuation in part of U.S. Non-Provisional patent application Ser. No. 18/477,913, filed Sep. 29, 2023 and entitled “System for RFID Edge Zone Identification and Data Capture”.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Apropos of the normative Internet of Things, sensors are commonly associated with things within a facility to capture individualized data about things. Reader devices communicate with sensors to capture the resultant sensor data (commonly termed “downstream” communication), and package and send sensor data to host applications (commonly termed “upstream” communication).

A reader device is often located in proximity to a sensor such that the reader device communicates downstream with the sensor via an ultra-low-power, short-distance, high-performance radio protocol, which may be a standard protocol, or a protocol proprietary to the manufacturer of the sensor and reader device.

With respect to upstream communication there are two cases: the reader device and the host application are co-located on the same local-area network (commonly termed “local access”), or the reader device is located on the network edge and the host application is located in the Internet (commonly termed “remote access”).

In the local access case, reader devices communicate upstream with host applications via the reader device manufacturer's proprietary reader protocol, which is optimized to allow host applications to exert Dynamic Reader Device Control (as discussed herein), whereby the host application filters and manipulates sensor data by making rapid changes to reader device operation.

In the remote access case, reader devices communicate upstream with host applications via Hypertext Transmission Protocol (HTTP), or a protocol derived from HTTP like Message Queuing Telemetry Transport (MQTT). However, as discussed herein, HTTP has limitations that prevent host applications from exerting Dynamic Reader Device Control.

Therefore, the state of the art lacks a cohesive communication protocol for both local access and remote access. Furthermore, in the remote access case and with respect to enablement of Dynamic Reader Device Control, extant communication protocols are deficient.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of a host and a reader device performing a transaction utilizing a TT-REST protocol consistent with certain embodiments of the present invention.

FIG. 2 is a Post method request message format for TT-REST communication consistent with certain embodiments of the present invention.

FIG. 3 is a Put method response message format for TT-REST communication consistent with certain embodiments of the present invention.

FIG. 4 is a site diagram for dynamic reader control inference coverage in a facility consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

### Definitions

HOST—an application executing as a data processor at the network edge or across the Internet.
API—Application Programming Interface defines the means for a Host to command and control the system communication.
TAG—a low-power sensor usually in the form of an inexpensive label or marker affixed to an item, asset, or object and utilized to identify that particular item, asset, or object. A Tag may be passive, communicating without on-board power by absorbing and reflecting ambient energy, or active, beaconing and receiving by battery power.
READER DEVICE—communicates with a multiplicity of Tags to control Tag response and behavior, to detect and capture Tag data, and to package and send Tag data to a Host.
TWP—Tag Wireless Protocol is a low-power, short-distance, wireless protocol for communication between a Tag and a Reader Device. A TWP specification, whether it is standards-based or proprietary, does not describe how the TWP is used to deliver value.
RHP—Reader Host Protocol is a communication protocol to connect a Reader Device and a Host over a network. Via a Reader Device, an RHP provides a Host with control over the TWP and access to TWP parameters. An RHP specification, whether it is standards-based or proprietary, does not describe how the TWP is used to deliver value.
JSON—JavaScript Object Notation is a human-readable, text-based format for structured data exchange.
REST—Representational State Transfer is a set of principles for designing networked applications emphasizing resource-based transactions.
TT-REST Message Protocol—A REST-based protocol that defines a message format and a generalized set of transactions for communication and control between a Host and a Reader Device.
WebSocket—a standards-based communication protocol that provides a persistent, efficient, full-duplex communication channel over a single TCP connection between a server and a client, for example, a Host and a Reader Device; where TCP is Transmission Control Protocol, a main protocol of TCP/IP, the Internet Protocol stack.
DRDC—Dynamic Reader Device Control, further defined herein, is the process undertaken by a Host to repeatedly, rapidly and with low latency modify the operation of a Reader Device for the purpose of selecting and manipulating a Tag or a set of Tags.
Reader Device Message Layer—is an encapsulation of a communication protocol, a message format, and an API to enable a Reader Device to communicate with a Host.
Entity—is a tagged real-world item or object with an identity of such importance that it is valuable to have timely awareness of non-static physical attributes, like but not limited to position, movement, and relation to other Entities.

### Dynamic Reader Device Control

To improve data capture and analysis in network connected devices such as, in a non-limiting example, Internet of Things (IoT) sensors connected through reader devices to networks, this document sets forth Dynamic Reader Device Control (DRDC) as a means to enable the Host, a control process executing either at the Internet edge or in a network connected cloud environment, to rapidly modify the operation of a Reader Device, comprising a Tag-based data capture process executing on the Internet edge, to select and manipulate Tags. DRDC makes novel use of the Reader Device API and the TT-REST Message Protocol that together comprise the Reader Device Message Layer as herein defined, and the Web Socket communication protocol (WebSocket), which is a standard communication protocol based on Hypertext Transport Protocol (HTTP) as the data transport for the Reader Device Message Layer.

The term Tag denotes an IoT sensor identifying an entity (as an example but not limited to a physical asset or trade item). In comparison to other IoT sensor types, a Tag is distinguished as relatively simple, low-power, and inexpensive-often, but not limited to, being manufactured in passive form as a battery-less chip bonded to a foil antenna in a sticker-label format, or in active form as a battery-powered beacon in a marker format.

### Tag Radio Protocol

A Reader Device communicates downstream with a multiplicity of Tags utilizing a Tag Wireless Protocol (TWP) that specifies Tag response behavior, selection, and data encoding.

One TWP is GS1 UHF Gen2 (www.gs1.org/standards/rfid), which ISO/IEC has standardized as 18000-63, and is known commonly as RAIN RFID (“www.rainrfid.org/about-rain/what-is-rain”). Another TWP is Bluetooth Low Energy (BLE) as published by Bluetooth SIG, Inc. in Volume 6 Part A (Physical Layer Specification) of Bluetooth Core Specification V4.0 (“www.bluetooth.org/docman/handlers/downloaddoc.ashx?doc id=229737”).

These examples are not inclusive, as many standards-based and proprietary TWPs have been commercialized.

### Reader Host Protocol and the LAN Constraint

When the Reader Device and Host are co-located on a local-area network, the Host is a Local Host. The Reader Device communicates upstream with a Local Host via the Reader Host Protocol (RHP), which is optimized to provide a Local Host with control over the TWP and access to TWP parameters, and to enable a Local Host to filter and manipulate sensor data by making rapid changes to Reader Device operation (“Dynamic Reader Device Control” as discussed herein).

Low Level Reader Protocol (“www.gs1.org/standards/epc-rfid/epc-rfid-llrp/1-0-1”) (LLRP) is one such RHP published by GS1 as a standard for RAIN RFID applications. Because LLRP requires explicit knowledge of RAIN RFID radio protocols, it can be perceived as hard to apply, so Reader Device manufacturers usually offer a proprietary RHP to encapsulate and simplify LLRP.

By design, the RHP must communicate in peer-to-peer mode (defined as bidirectional communication where either endpoint may make requests), which requires that the Local Host and the Reader Device reside on the same Local Area Network (LAN) as a constraint on communication: the “LAN Constraint”. As a practicality, the LAN Constraint increases the number of physical devices in a facility-Local Host server devices in addition to Reader Devices—which increases cost and complexity.

### Using DRDC to Control Tag Response Behavior

A Host exerts DRDC via the RHP to rapidly vary the response behavior of a Tag or set of Tags. For the standards-based RAIN RFID TWP, the Host may control the following Tag response behaviors. This list is not exhaustive: RAIN RFID and other TWPs may have other controllable response behaviors.
Mask Selects Tag response by masking Tag identity properties like Electronic Product Code (EPC).
RfMode Specifies the modulation and data rate for the link between Reader Device and Tags to handle interference from nearby Reader Devices.
SearchMode Specifies whether a Tag responds once or repeatedly.
Session Specifies how long a Tag quiesces after a response to allow other Tags to respond.
TagPopulation Estimates the tag population in the RF field of view.
TransmitPower Controls Reader Device transmission power level.
ReceiveSensitvity Controls Reader Device sensitivity to weak Tag signals.

By rapidly changing Tag response behavior and sampling the variation in Tag responses, the Host may compute physical properties of an Entity (a tagged item or object) such as, in a non-limiting example, Directionality (an Entity's relative direction of travel) and Position (an Entity's relative spatial location). The Local Host also may collect physical properties the Tag may be capable of sensing, which may include, but are not limited to, Temperature, Moisture, Accelerometry, and Luminosity. Altogether, physical properties such as these, combined with known Entity metadata, reveal the real-world disposition of Entities in an autonomous and continuous fashion that otherwise would require laborious inspection, or even be infeasible.

### Communication Over the Internet

When the Reader Device is located on the network edge and the Host is located in the Internet, the Host is a Remote Host. To interact over the Internet, the Reader Device must communicate upstream to a Remote Host via Hypertext Transmission Protocol (HTTP), or a protocol derived from HTTP like Message Queuing Telemetry Transport (MQTT). An RHP depends on peer-to-peer mode and cannot operate over the Internet.

Using MQTT has drawbacks. The MQTT Publish/Subscribe and Request/Response data transport functions operate in client-to-server mode, which is not a bidirectional communication as provided by peer-to-peer mode. MQTT also requires a third-party “MQTT Central Broker” component to serve as a communication broker between the Reader Device and the Remote Host. These factors serve to make the MQTT protocol an unsuitable vector for DRDC.

### Advantages of WebSocket Versus MQTT

In contrast to MQTT, WebSocket operates in the same manner regardless of the Host's location. A WebSocket instance commences when the Reader Device sends an HTTP initialization request to a Host (local or remote), where the Host may be a networked server either connected to a local area network, cloud network, or other networked system. The WebSocket instance then switches to peer-to-peer mode with router-persisted connections so that both the Host and the Reader Device can communicate efficiently. In further contrast to MQTT, WebSocket has lower latency in data communication transfers, is easier to implement, is more extensible, and is ubiquitous across the Internet. Despite these advantages, commercial Reader Devices have not exploited Web Socket because the state-of-the-art WebSocket protocol lacks a Reader Device Message Layer.

The TT-REST Protocol encapsulates the Trilliott Reader Device API to add a Reader Device Message Layer to WebSocket, thereby creating the means for a Host to exert DRDC whether the Host is local or remote. DRDC permits the Host to dynamically and rapidly modify Reader Device behavior to control how the Reader Device selects, manipulates, and reports information from a Tag or set of Tags.

### Inference of Application and Capture Zone

The innovative system connects a Host, whether local or remote, to a plurality of Reader Devices in a facility; whereby each Reader Device collects data from a plurality of Tags affixed to Items, where an Item is an asset, an inventory unit, a marker at a known stationary position, or other physical object of interest. The Reader Devices and Tags are utilized in the innovative system where Tags may be either stationary or moving from location to location throughout a facility in which the system is installed.

Tag location is a critical datum in a system's inference of Application: the current use case of an Item identified by its Tag. A system implementation, utilizing data gathered through the action of Dynamic Reader Control, may infer Application by coupling inferred Tag location with metadata: the system-wide data defining an Item's rules of operation and its emergent state. Application answers the perennial questions, “where is it, and what is it doing?”

In an embodiment, a Capture Zone is a volume inferred from streams of Tag data detected when a Reader Device, either handheld, mounted on a vehicle, or mounted in a fixed location, is activated. In a non-limiting example, a Capture Zone may be defined by or inferred from a particular volume in a space that contains one or more items each having an Item Tag. The Host may activate the Reader Device to define the Capture Zone based upon motion of the handheld or vehicle mounted Reader Device or based upon the motion of quantities of Item Tags moving through a fixed location that are detected by the Reader Device as they pass through the Capture Zone identified for the fixed location.

The Capture Zone may be a three-dimensional (3D) volume developed or inferred by the system where the extent of the volume in x, y, and z axes is relative to the received signal strength (RSSI) of signals received from Tags located within the signal depth of the field projected by the Reader Device. The signal strength is related to the transmission power of the Reader Device; the greater the power used to transmit the signal, the larger the Capture Zone that can be defined. In this manner, a Capture Zone may be established that is specific or customized to a particular volume based upon the location of the Reader Device and the power of the signal that can be generated by the Reader Device when activated.

The Host, activating each reader device by Dynamic Reader Device Control (DRDC), can rapidly fluctuate each reader device by verifying parameters including transmission power and filters, to dynamically shape the Capture Zone to a zone dimension and extent to define a capture zone volume within which Tags may be accurately located, and counted, and from which Item identity and metadata may be collected from which the Capture Zone may be inferred.

In a non-limiting example, multiple signal activations by multiple Reader Devices may be used to both define the 3D volume of a Capture Zone, and capture Tag information from all Tags located within the Capture Zone, whether the Tags are stationary or moving within the Capture Zone. The multiple signal activations from multiple Reader Devices produce multiple data samples from all Tags. The multiple signal activations coupled with motion of the Reader Devices, or motion of the Tags through a stationary Capture Zone, permit the system to infer the location in three dimensions of each Tag within the Capture Zone. Another implementation may utilize a Tag accelerometer sensor coupled with the RSSI data to increase the confidence of the 3D location of each Tag within the Capture Zone.

In a non-limiting example, when the Reader Device activates and sends a signal out into the Capture Zone, all Tags within that capture zone report tag information, including metadata, associated with each Tag as information to be collected from each Tag. In a hospital environment, Tags may be emplaced on stationary items such as fixed furniture or may be emplaced on mobile assets such as movable equipment, beds, medical equipment or other assets creating a Capture Zone containing both stationary and moving Tags. In this example, the system is capable of both locating stationary Tags and following the motion of Tags through the Capture Zone and receiving tag identification and metadata for each Tag. In this way, tags emplaced on movable assets or equipment such that these items may be tracked via application inference and more readily located and inventoried.

In another non-limiting example, a facility that serves as a warehouse for corporate inventory may utilize the system by tagging inventory moving into and out of the warehouse, where aisles, bays, and racks are associated with Capture Zones. Reader Devices capture Tag data to accommodate moves, adds, and changes of all inventory contained within the warehouse. Application information inferred from each Item is analyzed, aggregated, and sent to the manufacturer or owner that placed the inventory within the warehouse. The system enables accurate and autonomous stock audit, pick, remove, replace, and addition transactions to be made to inventory records. The system enables the manufacturer or owner of the inventory to track each item all the way through the life cycle of the item within the facility.

### Reader Device API and TT-REST Message Protocol

From the network edge, a Reader Device initiates a connection to a Host, which directs the operation of the Reader Device according to a workflow, receiving, capturing, and saving in electronic storage the data generated by the Reader Device.

A Reader Device acquires a Tag from one or more Entities, where an Entity is a remote physical object, e.g., an inventory or asset item, and a Tag bears a code describing the Entity.

From a Tag, a Reader Device acquires the unique identity of an Entity and may compute physical entity attributes like directionality, defined as an Entity's relative direction of travel, and position, defined as an Entity's relative spatial location. In addition, a Reader Device may report entity attributes the Tag may be capable of detecting, such as, in non-limiting examples, temperature, moisture, accelerometry, or luminosity.

The Reader Device API installed with the innovative system provides an application program interface to configure, control, and direct a Reader Device, receive Entity identity, and, depending on device capability, receive directionality, position, and Tag attributes. The Reader Device API is encapsulated by the TT-REST Message Protocol.

The Reader Device API defines the interface between the Reader Device and the Host in such a way as to be agnostic to whether the connection between the Reader Device and the Host is across a local-area network, or across the Internet.

### TT-REST Message Protocol

In an embodiment, to establish client and server communication utilizing the TT-REST Message Protocol, a client initiates a WebSocket connection by sending an HTTP request to the server URL. The HTTP request specifies the HTTP Get method and upgrade header seeking to switch to WebSocket operation. The HTTP URI scheme utilizes “ws://” (non-secure) or “wss://” (secure) headers instead of “http://” or “https://”. Transport Layer Security (TLS) encrypts communication for the “wss://” scheme, although on local networks TLS may be considered optional.

The system server responds with a handshake upgrading to WebSocket headers for data communication. Thereafter, the client and server's TCP connection protocol switches from HTTP to WebSocket, which enables full-duplex, peer-to-peer, asynchronous transmission between client and server. Internet routers along the TCP connection persist the path. Transactions between the client and server utilizing the WebSocket connection may consist of many requests and responses originating from either side. Since a WebSocket's TCP connection does not time out, when communication is finished the connection is closed by either the client or server side.

WebSocket defines an unstructured message transmission pipe. Unlike HTTP and MQTT, WebSocket does not have method concepts like HTTP Post, Put, Get, Delete, nor MQTT Connect, Disconnect, or Publish. Additionally, Web Socket does not have the REST concept of a Resource that is transacted upon. The concept of Methods transacting upon Resources is a robust contribution to good application design, and is featured fortuitously in the standard-based JSON-RPC 2.0 Specification (www.jsonrpc.org/specification). Therefore, the TT-REST Message Protocol design and implementation incorporates the JSON-RPC Specification. In this embodiment, the JSON-RPC Specification provides standard data structures and the rules for their processing, and incorporates the invocation of a method with parameters.

The TT-REST Message Protocol overrides JSON-RPC method syntax with REST-ful Actions that transact upon Resources.

### Originator and Respondent Roles

In an embodiment, a TT-REST message exchange follows the WebSocket protocol comprising a request action message from the “originator” followed by a synchronous response message from the “respondent”. Herein, an originator is often a Host and the respondent a Reader Device, where the Reader Device may be handheld, vehicle mounted, or fixed-location mounted. Furthermore, the term “originator” can replace the common term “client”, and “respondent” the common term “server”. Because the asynchronous and peer-to-peer aspects of WebSocket allow either endpoint at any time to be an originator requesting work from the respondent, the originator and respondent roles are reversible.

### Incorporation of HTTP-REST

A TT-REST session is dedicated between the endpoints to handle one or more Transactions, where a Transaction comprises one or more Request-Response exchanges originating from either endpoint until the workflow commenced by the originator is satisfied.

Of the standard HTTP methods, TT-REST employs Post and Put methods. TT-REST omits other methods in favor of Post Actions, by which an originator invokes an Action on a respondent Resource. One or more Actions are defined for each Transaction type according to the Transaction workflow.

To provide context for the execution of a Post Action request, the originator can send a request bearing parameters (aka params or Params). To provide context for the invocation result, the respondent can send a synchronous response bearing Params. Furthermore, either endpoint can asynchronously send Put bearing an array of Record objects. In both cases, Parameter and Record objects are relevant to the Transaction workflow. Finally, a Record can be an Event bearing Params informing the other endpoint of a change of Transaction status.

The TT-REST Message Protocol Methods and Actions are presented in the following table:

| Method | Action | Description |
|---|---|---|
| Post | Allocate | Originator invokes the Allocate |
| | | Action to start a new Session. |
| | Deallocate | Either endpoint invokes the Deallocate |
| | | Action to release the Session. |
| | Action . . . | Either endpoint invokes an Action |
| | | Request relevant to the Transaction, |
| | | where the Request contains Parameters, |
| | | and the synchronous Response |
| | | may also contain Parameters. |

| | |
|---|---|
| Put | Either endpoint sends asynchronous Request |
| | containing an array of Record or Event. |

### Protocol Alignment and Extension

Transactions are defined according to a Reader Host Protocol (RHP), which aligns with a commercial Reader Device. Transactions may be modified, added, or obsoleted per new commercial Reader Device features, when such features are added to the RHP.

Params are defined according to the Reader Device's Tag Wireless Protocol (TWP) support, which aligns with one or more standard radio protocols, like the UHF Gen 2 RFID or Bluetooth Low Energy protocols, or a similar proprietary radio protocol. Params may be modified, added, or obsoleted as protocols evolve and updates are added to each protocol.

### Response Codes

The TT-REST result codes comprise a subset of standard HTTP-REST status codes. An error message accompanies the response as outlined in the table below.

| Return | | |
|---|---|---|
| Code | Meaning | Request Method |
| 200 | OK. Request has succeeded | Post or Put |
| 201 | Created - a new Session has been created | Post Allocate |
| 400 | Bad Request | All |
| 401 | Unauthorized - authentication failed | Post Allocate |
| 405 | Method (Action) not allowed | Post |
| 500 | Internal Error | All |

### URI Format

The initial HTTP Request contains a Uniform Resource Identifier (URI). The Scheme for the URI is “wss:” if TLS-based Secure Socket Layer (SSL) is enabled, or “ws:” otherwise. The Uniform Resource Locator (URL) is in the standard “//address: port” format that routes the Request. Thereafter the connection is upgraded to WebSocket protocol where subsequent Requests and Responses do not bear a URI. Methods, Resources, and Parameters are embedded in the JSON-RPC message body.

### Request Message Format

A TT-REST message body must be formatted as JSON-RPC. Each JSON object must have as its first member the $type property specifying the object type descriptor for deserialization.

A TT-REST Request must have a method (aka Method) member with value formatted in the REST style specifying: a) Post or Put, b) a couplet identifying the Session by its resource category and unique key, c) one or more couplets identifying the Resource being transacted upon, and d) for Put, an Action couplet, or for Put, an Entity Type specifying the Entities being submitted.

A TT-REST Request must have a params object with parameters as defined for the Transaction, and an Id member with value unique for this Request-Response exchange.

A TT-REST Response must have an Id string matching the Request Id and must have a Result or Error object with a Code number and Message string. As defined for the Transaction, a Response may have additional parameters or may have a Params object.

### Response Message Format

A TT-REST Response must have an Id string matching the Request Id and must have a Result or Error object with a Code number and Message string. As defined for the Transaction, a Response may have additional parameters or may have a Params object.

### Allocate Transaction

An HTTP client invokes the Allocate Action to start a new session with the server. The client must set Key in the Session Couplet to the placeholder value “!” and must specify one or more Resource Couplets, as defined for the resource, with the final Resource Couplet giving the client's unique name for the resource.

In an embodiment, authentication via a UserId: Password credential may be considered optional. TLS encryption may be considered optional on local networks but must be enabled for edge to cloud connections.

The client must initiate authentication and include a Params object with a credential member formatted as a UserId: Password string. Note: if encryption is not enabled the authentication credential may be exposed.

The client must include in the Params object a resource member formatted as a Resource Couplet identifying the client resource to which the server responds.

In the Response, the server must include a Credential member with a unique Session Key.

In a non-limiting example, an HTTP client invokes allocate on a server as follows:

| | |
|---|---|
| ⋄ | originator ws://192.168.12.4:80/ |
| [symbol] | [symbol] $type [symbol] : [symbol] Request [symbol] , |
| | [symbol] method [symbol] : [symbol] post/devices/ !/instances/ reader1 /actions/ allocate [symbol] , |
| | [symbol] params [symbol] : [symbol] |
| | [symbol] $type [symbol] : [symbol] Params [symbol] , |
| | [symbol] Credential [symbol] : [symbol] Userid:Password [symbol] |
| | [symbol] Resource [symbol] : [symbol] devices/cie6qcg2nbqqeyz6r2e5 [symbol] }, |
| | [symbol] id [symbol] : [symbol] bz53fqv3mztr9y [symbol] xcv14 [symbol] |
| [symbol] | respondent |
| [symbol] | [symbol] $type [symbol] : [symbol] Response [symbol] , |
| | [symbol] result [symbol] : [symbol] |
| | [symbol] $type [symbol] : [symbol] Result [symbol] , |
| | [symbol] Code [symbol] : 200, |
| | [symbol] Message [symbol] : [symbol] , |
| | [symbol] Credential [symbol] : [symbol] H55AEOX5Y45Y5PHDCFGE [symbol] }, |
| | [symbol] id [symbol] : [symbol] bz53fqv3mztr9ywxcv14 [symbol] } |

[symbol]

indicates data missing or illegible when filed

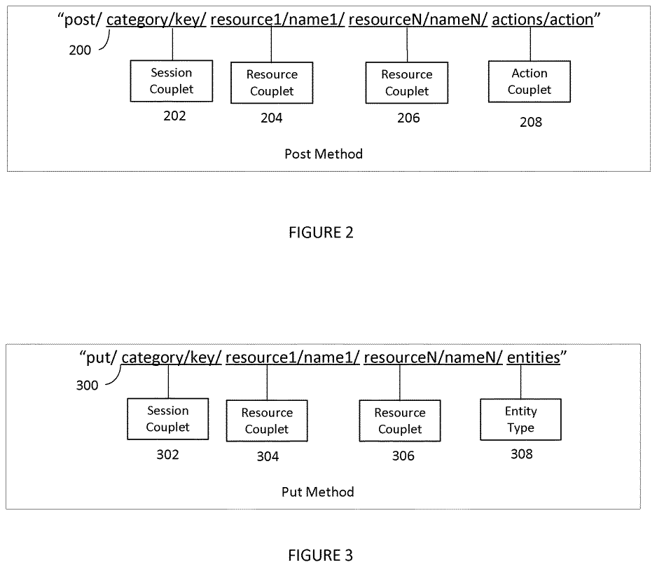

In subsequent Requests, the WebSocket has switched to peer-to-peer mode. The request originator evidences authentication by placing Session Key in the Session Couplet, as illustrated in FIG. 2.

### Scan Transaction

To initiate a Scan Transaction, as shown in the following a non-limiting example, the Host commences as the originator, posts Scan to the Reader Device with a params object containing ScanParameters configuring the Reader Device Scan action. See ScanParameters Object below.

Thereafter, the Reader Device becomes the originator and continuously invokes a Put request to submit Tag reports to the Host until the Host invokes the Post Stop action. A Tag report is wrapped in a params object as a Tag Object array, see Tag Object below.

| ⋄ | Host | |
|---|---|---|
| [symbol] | [symbol] $type [symbol] : [symbol] Request [symbol] , | |
| | [symbol] method [symbol] : [symbol] post/devices/cie6qcg2nbqqeyz6r2e5/instances/ reader1 /actions/ scan [symbol] , | |
| | [symbol] params [symbol] : [symbol] $type [symbol] : [symbol] Params [symbol] , [symbol] TransmitPower [symbol] : 30.0, [symbol] AntennaHeight [symbol] : 365, | |
| | | [symbol] Masks [symbol] : [symbol] MemoryMask [symbol] : [symbol] 3314 [symbol] , [symbol] MemoryBank [symbol] : 1, [symbol] BitCount [symbol] : 16, |
| | | [symbol] Bi [symbol] Offset [symbol] : 32, [symbol] Match [symbol] : true [symbol] |
| | [symbol] id [symbol] : [symbol] tz8J0P1KdUeRYqdF [symbol] 77q [symbol] | |
| [symbol] | Reader Device | |
| [symbol] | [symbol] $type [symbol] : [symbol] Response [symbol] , | |
| | [symbol] result [symbol] : [symbol] $type [symbol] : [symbol] Result [symbol] , [symbol] Code [symbol] : 200, [symbol] Message [symbol] : [symbol] OK [symbol] }, | |
| | [symbol] id [symbol] : [symbol] tz8J0P1KdUeRYqdF277q [symbol] | |
| [symbol] | Reader Device | |
| [symbol] | [symbol] $type [symbol] : [symbol] Request [symbol] , | |
| | [symbol] method [symbol] : [symbol] put/devices/H55AEOX5Y45Y5PHDCFGE/instances/ reader1 /tags [symbol] , | |
| | [symbol] params [symbol] : [symbol] $type [symbol] : [symbol] Params [symbol] , [symbol] Tags [symbol] : [symbol] | |
| | [symbol] | [symbol] $type [symbol] : [symbol] Tag [symbol] , [symbol] DetectedWhen [symbol] : [symbol] 2021-08-04T06:55:58.0689842 [symbol] , |
| | | [symbol] Epc [symbol] : [symbol] 303428F0D861A84000002028 [symbol] , [symbol] Antenna [symbol] : 1 [symbol] , |
| | [symbol] | [symbol] $type [symbol] : [symbol] Tag [symbol] , [symbol] DetectedWhen [symbol] : [symbol] 2021-08-04T06:55:58.6986652 [symbol] , |
| | | [symbol] Epc [symbol] : [symbol] 303428F0D861A84000000101 [symbol] , [symbol] Antenna [symbol] : 1 [symbol] , |
| | [symbol] | [symbol] $type [symbol] : [symbol] Tag [symbol] , [symbol] DetectedWhen [symbol] : [symbol] 2021-08-04T06:55:58.7004942 [symbol] , |
| | | [symbol] Epc [symbol] : [symbol] 303428F0D861A84000120458 [symbol] , [symbol] Antenna [symbol] : 1 [symbol] |

| | |
|---|---|
| | [symbol] id [symbol] : [symbol] c6b82sbnb77kq8hs5c9u [symbol] |
| ⋄ | Host |
| [symbol] | [symbol] $type [symbol] : [symbol] Response [symbol] , |
| | [symbol] result [symbol] : [symbol] $type [symbol] : [symbol] Result [symbol] , [symbol] Code [symbol] : 200, [symbol] Message [symbol] : [symbol] OK [symbol] }, |
| | [symbol] id [symbol] : [symbol] c6b82sbnb77kq8hs5c9u [symbol] |
| [symbol] | Reader Device |
| [symbol] | [symbol] $type [symbol] : [symbol] Request [symbol] , |
| | [symbol] method [symbol] : [symbol] put/devices/H55AEOX5Y45Y5PHDCFGE/instances/ reader1 /tags [symbol] , |
| | [symbol] params [symbol] : [symbol] $type [symbol] : [symbol] Params [symbol] , [symbol] Tags [symbol] : [symbol] Tag, Tag, Tag, ... [symbol] }, |
| | [symbol] id [symbol] : [symbol] auF1QIRv2kGyPnKUojkq [symbol] |
| ⋄ | Host |
| [symbol] | [symbol] $type [symbol] : [symbol] Response [symbol] , |
| | [symbol] result [symbol] : [symbol] $type [symbol] : [symbol] Result [symbol] , [symbol] Code [symbol] : 200, [symbol] Message [symbol] : [symbol] OK [symbol] }, |
| | [symbol] id [symbol] : [symbol] auF1QIRv2kGyPnKUojkq [symbol] |

[symbol]

[symbol]

[symbol]

indicates data missing or illegible when filed

### Termination

To terminate a transaction, the Host invokes the Post Stop action. Thereafter, the Host may make additional invocations, or may terminate the session via Post Deallocate. If the WebSocket is terminated by either side or by disconnection, the Reader Device is responsible for re-initiating the connection with periodic Post Allocate requests.

### ScanParameters Object

In an exemplary embodiment, the ScanParameters Object comprises the following fields formatted as JSON data pairs:

| Field | Value | Description |
|---|---|---|
| $type | string | Type descriptor: “Params” |
| AntennaHeight | number | Spatial reader antenna height in integer cm, |
| | | e.g., 244 cm = 8 ft, 183 cm = 6 ft. Default value is 244. |
| Masks | object [ ] | Specifies a set of Mask objects specifying how tags are |
| | | filtered at the antenna. See Mask Object |
| ReportDetail | number | Enumeration value specifying tag properties returned for |
| | | each tag report. Values are OR'ed to add Tag properties to |
| | | the report. See ReportDetails Enumeration. |
| RfMode | number | Enumeration value specifying the modulation and data rate |
| | | for the link between Reader Device and Tags. See RfModes |
| | | Enumeration. |
| SearchMode | number | Enumeration value specifying how Reader Device singulates |
| | | Tags once or repeatedly. See SearchModes Enumeration. |
| Session | number | Enumeration value specifying how long a tag waits to re- |
| | | respond to a Reader Device query, and how it maintains |
| | | independent states for response to multiple readers. See |
| | | Sessions Enumeration. |
| TagPopulation | number | Integer estimate of Tag population in the RF field of view, |
| | | rounded to next power of 2. |
| TransmitPower | number | Transmit power in decimal Db values from 0 to 32.0. |

### Mask Object

The Mask object comprises the following fields formatted as JSON data pairs.

| Field | Value | Description |
|---|---|---|
| $type | string | Type descriptor: “Mask” |
| BitCount | number | Specifies the integer count of mask bits included in the filter. |
| BitOffset | number | Enumeration value specifying the bit offset into the memory |
| | | bank. See BitOffsets Enumeration. |
| Boolean | number | Enumeration value specifying how multiple masks are |
| | | combined to form a match. See Booleans Enumeration. |
| Match | boolean | Specifies if the filter returns true on a match, or false. |
| MemoryBank | number | Enumeration value specifying which EPC memory bank |
| | | extent this mask operates on. See MemoryBanks |
| | | Enumeration. |
| MemoryMask | string | Specifies an EPC mask as a hex string. |
| Session | number | Specify how long a Tag waits to re-respond to a Reader |
| | | Device query, and how it maintains independent states for |
| | | response to multiple Reader Devices. See Sessions |
| | | Enumeration. |

### Tag Object

The Tag object comprises the following fields formatted as JSON data pairs.

| Field | Value | Description |
|---|---|---|
| $type | string | Type descriptor: “Tag” |
| DetectedWhen | string | Reports tag capture timestamp as date string formatted as |
| | | “yyyy-MM-ddThh:mm:ss.ffffffZ”. |
| Direction | number | Enumeration value reporting the direction of Tag |
| | | movement. See Direction Enumeration. |
| EPC | string | Reports Tag EPC as hex string. |
| N | number | Reports Tag capture count since the last tag report as |
| | | integer. |
| PeakRSSI | number | Reports peak tag RSSI since the scan transaction started as |
| | | integer. |
| Position | number [ ] | Reports Tag position as array of X, Y, C, with X and Y as |
| | | double floating point, and C (Confidence) as integer. |
| TagId | string | Reports Tag EPC TagId as hex string, if requested by |
| | | ScanParameters ReportDetail. |

### BitOffsets

Specifies the bit offset into the EPC memory bank.

| Value | Caption | Description |
|---|---|---|
| 0 | CrcPc | CRC + Protocol Control |
| 32 | EpcId | EPC ID |

### Booleans

Specifies how multiple masks are combined to indicate a Tag match.

| Value | Caption | Description |
|---|---|---|
| 0 | None | Select the Tag if no mask matches the Tag. |
| 1 | All | Select the Tag if all masks match the Tag. |
| 2 | Any | Select the Tag if any mask matches the Tag. |

### Directions

Reports the direction of tag movement relative to the orientation of the Reader Device.

| Value | Caption | Description |
|---|---|---|
| 0 | LeftRight | Tag is moving left to right. |
| 1 | RightLeft | Tag is moving right to left. |
| 2 | TopBottom | Tag is moving top to bottom. |
| 3 | BottomTop | Tag is moving from bottom to top. |

### Memory Banks

Specifies which EPC memory bank extent this mask operates on.

| Value | Caption | Description |
|---|---|---|
| 0 | Reserved | Reserved |
| 1 | Epc | Start of the EPC memory extent. |
| 2 | Tid | Start of the Tag Id memory extent. |
| 3 | User | Start of the User memory extent. |

### Report Details

Specifies how tag properties are returned for each tag report. Values are OR'ed to add Tag properties to the report.

| Value | Caption | Description |
|---|---|---|
| 0 | Epc | EPC only (default). |
| 1 | TidEpc | TID + EPC (Impinj Fast TID if available). |
| 2 | Antenna | Antenna number. |
| 3 | SeenCount | TID + EPC + SeenCount. |

### Rf Modes

Specifies the modulation and data rate for the link between Reader Device and Tags.

| Value | Caption | Description |
|---|---|---|
| 0 | MaxThroughput | Low interference from other Reader Devices. |
| 1 | Hybrid | Modest interference from other Reader Devices. |
| 2 | Dense4 | Moderate to high interference from high reader density. |
| 3 | Dense8 | Low read rate for extreme radio interference. |
| 4 | MaxMiller | Maximum read reliability, low read speed, for low Tag |
| | | population density. |
| 1000 | AutoDense | Reader chooses for Tags in motion (Impinj). |
| 1002 | AutoDenseDeep | Reader chooses for static Tags (Impinj). |
| 1003 | AutoStaticFast | Reader chooses for static, easily-read Tags (Impinj). |
| 1004 | AutoStaticDense | Reader chooses for static, hard-to-read Tags, with low read |
| | | speed (Impinj). |

### Search Modes

Specifies how Reader Device singulates Tags once or repeatedly.

| Value | Caption | Description |
|---|---|---|
| 0 | Auto | Reader Devices selects mode (default). |
| 1 | Single | Use for high tag count, or for high throughput with fewer Tag |
| | | responses. Singulates Tags in A (active) then moves them to B |
| | | (quiet). |
| 2 | DualAtoB | Use for low to medium Tag count or low throughput for |
| | | repeated tag responses. Singulates Tags in A (active), moves |
| | | them to B (quiet), then repeats. Persistence in B is influenced |
| | | by Session. |
| 3 | TagFocus | Use for high throughput for a single response from each Tag. |
| | | For Impinj Monza Tags only. Singulates Tags set for Session 1 |
| | | (short persistence) with Monza TagFocus to suppress |
| | | responses for a long period while Tags are energized. |
| 5 | SingleReset | Use for high throughput via two queries, or a second Reader |
| | | Device. Singulates Tags in Session 2 or 3 (long persistence) B |
| | | (quiet), then moves them to A (active) to respond to a |
| | | subsequent query in Single mode, or one Reader Device in |
| | | SingleReset mode and another in Single mode. |
| 6 | DualBtoA | Use for high Tag count or high throughput for repeated Tag |
| | | responses. Singulates Tags A (active) then moves them to B |
| | | (quiet). Once all Tags are in B, moves all Tags back to A. |

### Sessions

Specifies how long a tag waits to re-respond to a Reader Device query, and how it maintains independent states for response to multiple Reader Devices.

| Value | Caption | Description |
|---|---|---|
| 0 | Session0 | Not for standard use |
| 1 | Session1 | Short persistence |
| 2 | Session2 | Long persistence |
| 3 | Session3 | Long persistence |

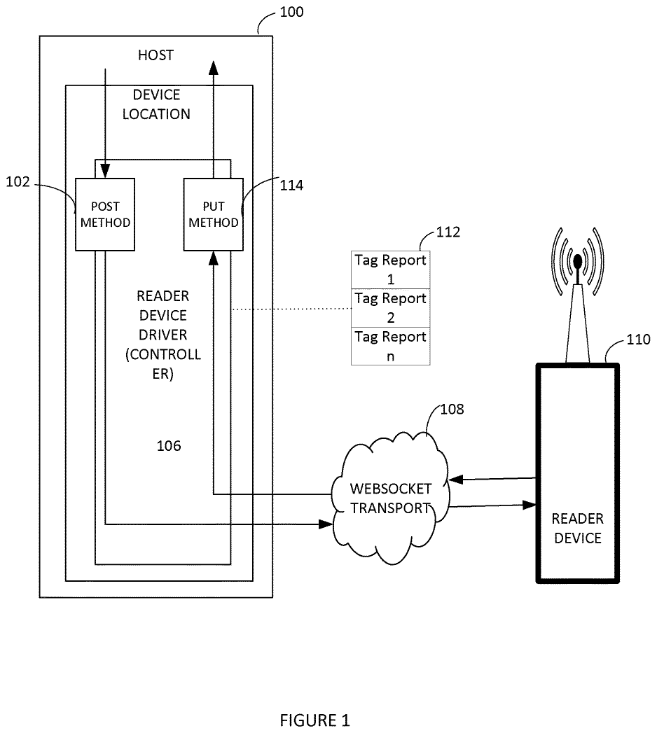

Turning now to FIG. 1, this figure presents a view of a Host and a Reader Device performing a transaction utilizing a TT-REST protocol consistent with certain embodiments of the present invention. In an embodiment, an originator invokes an action on the TT-REST server active on the Host 100 to capture data from tags within a facility to start a new session for data capture. The Host 100 transmits a Post action. The Reader Device driver controller 106 configures the action as a request utilizing the Web Socket protocol and transmits the Post request 102 through the WebSocket Transport 108 communication pathway across the network. The Reader Device 110 receives the request and, for example, commences data collection from one or more Tags in the facility, where the Tags are each associated with an item, asset, or physical location within the facility. The Reader Device compiles a Tag report 112 for each Tag from which data is collected. The Reader Device transmits Tag reports through the WebSocket Transport 108 communication pathway as a Put request 114. The Put request is received at the Host 100 and the data from each Tag report 112 is stored in electronic storage.

Turning now to FIG. 2, this figure presents a Post method request message format for TT-REST communication consistent with certain embodiments of the present invention. In an embodiment, a post method request message is constructed with a post header 200, a session couplet 202 comprising a category for the message and a message key, an initial resource couplet 204 comprising the identity of the resource and name from which data is to be collected, additional resource couplets 206 for each resource from which data is to be collected, and an action couplet 208 identifying the actions requested.

Turning now to FIG. 3, this figure presents a Put method response message format for TT-REST communication consistent with certain embodiments of the present invention. In an embodiment, a Put method request message is configured with a Put header 300, a session couplet 302 comprising a category for the message and a message key, an initial resource couplet 304 comprising the identity of the resource and name from which data is to be collected, additional resource couplets 306 for each resource from which data is to be collected, and an entity type couplet 308 identifying the entities from which data is requested.

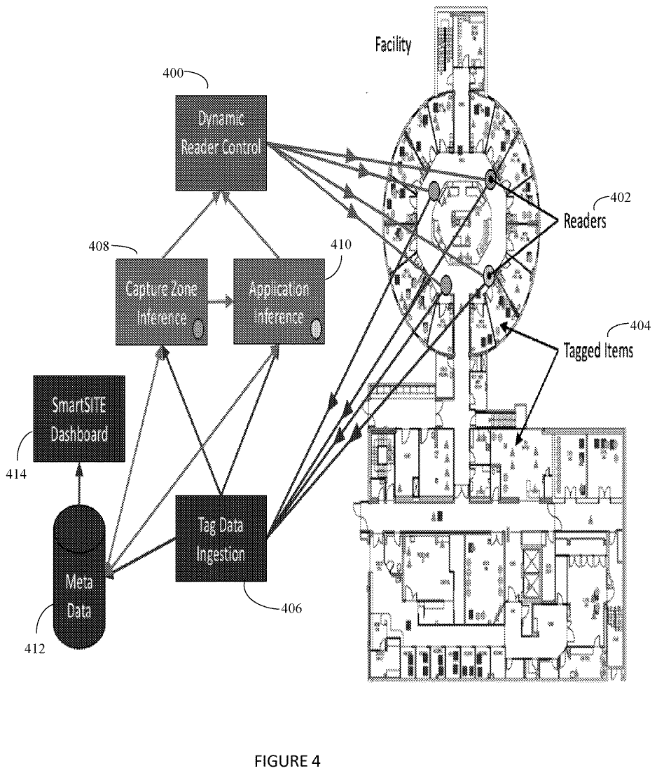

Turning now to FIG. 4, this figure presets a site diagram for dynamic reader control inference coverage in a facility consistent with certain embodiments of the present invention. In an embodiment, the process for data ingestion and inference begins with a signal transmitted from Dynamic Reader Control (DRC) 400 to each of the reader devices 402 that are emplaced within a facility. The reader devices 402 are active to interrogate all tagged items 404 that are within a defined capture zone relative to each reader device 402. Each reader device 402 collects tag information and metadata from each tagged item 404 and transmits the tag information and metadata to the tag data ingestion 406 component active on the host server. The tag information and metadata are transmitted to the capture zone inference engine 408, the application inference engine 410, and the electronic storage 412 maintained on the system server. The capture zone inference engine 408 infers the capture zone direction and extent as previously described by inferring the extent of the x, y, and z axes of the capture zone volume based upon the received signal strength (RSSI) of signals received from Tags located within the capture zone inferred volume. The application inference engine 410 tracks all tags within the inferred capture zone via application inference permitting all Tagged items to be more readily located and inventoried. The SmartSITE dashboard 414 receives all information and metadata from the metadata electronic storage 412 and presents the tag information to users on a user dashboard that is customized for each facility.

While certain illustrative embodiments have been described, it is evident that many alternatives, modifications, permutations and variations will become apparent to those skilled in the art in light of the foregoing description.

We claim:

1. A system for data collection, comprising:
one or more reader devices configured to collect data from a plurality of tags that incorporate a standard or proprietary tag-to-reader-device wireless communication protocol, for example but not limited to Radio Frequency Identification (RFID) tags;
a customized REST message protocol installed within each of said one or more reader devices;
a reader device application encapsulated and connected to said customized REST message protocol and installed within each of said one or more reader devices and configured to direct the operation of each of said one or more reader devices;
said reader device application configured to define a volume of space defined as a capture zone upon activation;
said reader device application further configured to scan said defined capture zone to collect information from each of a plurality of tags physically located within said capture zone whether the tags are stationary or in motion through said capture zone;
said reader device application active to receive tag data from each of said tags;
said reader device application activating a WebSocket instance utilizing said customized REST message protocol to establish bidirectional peer-to-peer communication between said reader device application and a host server, whereby the reader device and host server use said customized REST message protocol to communicate regardless of being collocated on a local area network or remotely connected over the Internet;
said reader device application transmitting all collected tag data to said host server for data analysis, event generation, and data display to one or more users.

2. The system for data collection according to claim 1, where the customized REST message protocol adds a reader device message layer to said WebSocket instance to enable direct reader device control for each of said reader devices from said host server.

3. The system for data collection according to claim 1, where said collected tag data comprise tag id, antenna id, date and time stamp information, number of times each tag was reported within a pre-set time interval, peak received signal strength information as well as data for managing collection and aggregation actions.

4. The system for data collection according to claim 1, where the capture zone volume is defined by multiple activations of a reader device coupled with the motion of said reader device to define a volume relative to the received signal strength of signals received from tags located within the signal depth of the signal field developed by the reader device.

5. The system of data collection according to claim 1, where each reader device is handheld, mounted on a vehicle, or mounted in a fixed location.

6. The system of data collection according to claim 5, where the capture zone for a reader device mounted in a fixed location is pre-defined from the signal strength of the reader device and tag data and metadata is collected by said reader device when one or more of said tags move through said pre-defined capture zone.

7. The system of data collection according to claim 1, where reader device activation sends a signal into a capture zone whereupon all tags within said capture zone report tag data and metadata associated with each of said tags to the reader device.

8. The system of data collection according to claim 1, where each of said tags is attached to or associated with a stationary or moving object or thing within said capture zone.

9. The system of data collection according to claim 1, further comprising said customized REST message protocol enabling dynamic reader device control through request-response control transactions from said host server directly to each of said reader devices.

10. The system of data collection according to claim 1, where the customized REST message protocol incorporates a JavaScript Object Notation (JSON) protocol defining standard data and request-response structures and processing rules for data communication enabling data collection, device control, and message transactions between said host server and each of said reader devices.
